(19) United States
(12) Patent Application Publication
(10) Pub. No.: US 2007/0139135 A1
(43) Pub. Date: Jun. 21, 2007

(54) Waveguide diplexer

(75) Inventors: Danny F. Ammar, Windermere, FL (US); Gavin Clark, Tavares, FL (US)

Correspondence Address: RICHARD K. WARTHER;ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: XYTRANS, INC., Orlando, FL (US)

(21) Appl. No.: 11/313,065

(22) Filed: Dec. 20, 2005

(51) Int. Cl. H01P 1/213

(52) U.S. Cl. 333/135

(57) ABSTRACT

A diplexer includes a diplexer housing having transmit and receive waveguide channels formed therein. A cover is received on the diplexer housing over the transmit and receive waveguide channels. A septum is inserted between the diplexer housing and cover and configured to provide isolation between any transmitter and receiver signals and a desired frequency band of operation.

### FIELD OF THE INVENTION

This invention relate to outdoor units used in microwave communications systems, such as millimeter wave (MMW) applications, and more particularly, to diplexers used in outdoor units.

### BACKGROUND OF THE INVENTION

The increased demand for high-speed, high data rate communications has created an immediate need for broadband access to the related network infrastructure. New applications include computer-to computer communications, gaming, and video-based services. Wireless solutions offer benefits in ease of deployment without the requirement of destroying streets to lay fiber. Wireless solutions also offer increased flexibility because new communication links can be added to the network as customers are added. Wireless solutions are also less expensive compared to optical fiber and hardwired solutions.

The use of millimeter wave (MMW) frequency bands allows wireless links to produce up to about an estimated one thousand times the data capacity of digital subscriber loop (DSL) or cable modem systems, and offer a higher bandwidth than available at lower operating frequencies. Currently, many terrestrial wireless systems are built using point-to-point, point-to-multipoint, Local Multipoint Distribution Services (LMDS), and mesh architectures. Each link end contains an indoor unit (IDU) and an outdoor unit (ODU). The indoor unit usually has a modem and a power supply. The outdoor unit, which represents about 60% of the cost of the link, typically contains a number of subassemblies, such as a millimeter wave transmitter and receiver or an integrated transceiver, a frequency synthesizer circuit, a power supply, a controller, and monitoring circuits.

One of the most challenging aspects of these types of wireless communication systems is to maintain the ability to operate in very specific frequency bands without interfering with adjacent bands. Although wide frequency bands (1 to 2 GHz) are available at millimeter wave frequencies, these bands typically are segmented and allocated in small channels of only a few megahertz (MHz). Regulatory rules, however, strictly dictate low interference levels from adjacent channels, and compliance with these high isolation requirements usually mandates the use of waveguide filters and a diplexer in any wireless system.

Waveguide filters and diplexers have been used extensively in communication systems to pass desired signals with low insertion loss, while rejecting unwanted signals. Because of the high level of segmentation of the frequency bands and the small channel width, dozens of different diplexers are typically required to cover each band. These waveguide filters and diplexers typically are long lead items and cost over $200 (two hundred dollars) in present day value, even when purchased in large quantity. It is not unusual for wireless radio manufactures to carry hundreds of waveguide filters/diplexers in inventory to cover an entire frequency band, thus allowing the manufacturer to react to changes in customer requirements in a reasonable time acceptable to a customer.

### SUMMARY OF THE INVENTION

A diplexer includes a diplexer housing having transmit and receive waveguide channels formed therein. A cover is received on the diplexer housing over the transmit and receive waveguide channels. A septum is inserted between the diplexer housing and cover and configured to provide isolation between any transmitter and receiver signals and a desired frequency band of operation.

In yet another aspect of the present invention, the transmit and receive waveguide channels can each be serpentine configured. The diplexer housing can include opposing sides and the respective transmit and the receive waveguide channels are formed on the opposing sides. An end cover can be received over each opposing side. Each end cover can have a respective waveguide channel engaging the respective waveguide channel within the housing. A common waveguide port can interconnect the transmit and receive waveguide channels.

In yet another aspect of the present invention, the septum can be formed by forming resonators within the septum for imparting a desired frequency band of operation and isolation between transmitter and receiver signals. In yet another aspect, the waveguide channels can be formed as multiple segments, each representing “n” number of poles. The diplexer housing can be formed as a base plate and the cover can include transmit and receive waveguide ports formed therein and operative with the transmit and receive waveguide channels.

### BRIEF DESCRIPTION OF THE DRAWINGS

Other objects, features and advantages of the present invention will become apparent from the detailed description of the invention which follows, when considered in light of the accompanying drawings in which:

FIG. 1 is an isometric view of a typical waveguide diplexer.

FIG. 2 is a graph showing a typical frequency response and return loss for a diplexer operating at about 18 GHz.

FIG. 3 is a block diagram of a typical microwave communications system that incorporates an outdoor unit and indoor unit and can be used in accordance with one non-limiting example of the present invention.

FIG. 4 is an isometric view of a typical waveguide filter used in some communications systems, which filter transmitted and receiver signals.

FIG. 5 is an exploded isometric view of typical cavity filter used in some communications systems.

FIG. 6 is an exploded isometric view of a typical cavity diplexer used in some communications systems.

FIG. 7A is an exploded isometric view of a typical septum filter used in some communications systems.

FIG. 7B is an isometric view of the assembled septum filter shown in FIG. 7A.

FIG. 8 is an exploded isometric view of a diplexer in accordance with one non-limiting example of the present invention.

FIG. 9 is an exploded isometric view of a wireless microwave link incorporating an antenna and outdoor unit and showing how the external diplexer of FIG. 8 mounts between the antenna and outdoor unit.

FIG. 10 is an exploded isometric view of a serpentine transmitter and receiver waveguide filter/diplexer in accordance with one non-limiting example of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

In accordance with one non-limiting example of the present invention, a low cost diplexer covers very wide frequency bands and can be set to specific narrow segments by changing an insert inside a waveguide. Radio manufacturers can reduce their inventory and reduce the cost of a diplexer by at least a factor of four (4) in present day economic terms.

In addition, waveguide filters and diplexers in accordance with non-limiting examples are reduced in size by implementing a serpentine septum filter, without sacrificing functionality, performance or reliability. The reduction in size has many benefits, including easier integration into communication systems.

For purposes of explanation, a brief explanation will follow of waveguides and diplexers and related filters to better understand the embodiments of the invention as described. As known to those skilled in the art, a waveguide is a passive device that controls the propagation of an electromagnetic wave so that the wave is forced to follow a path defined by the physical structure of the guide. Waveguides typically take the form of rectangular hollow metal tubes.

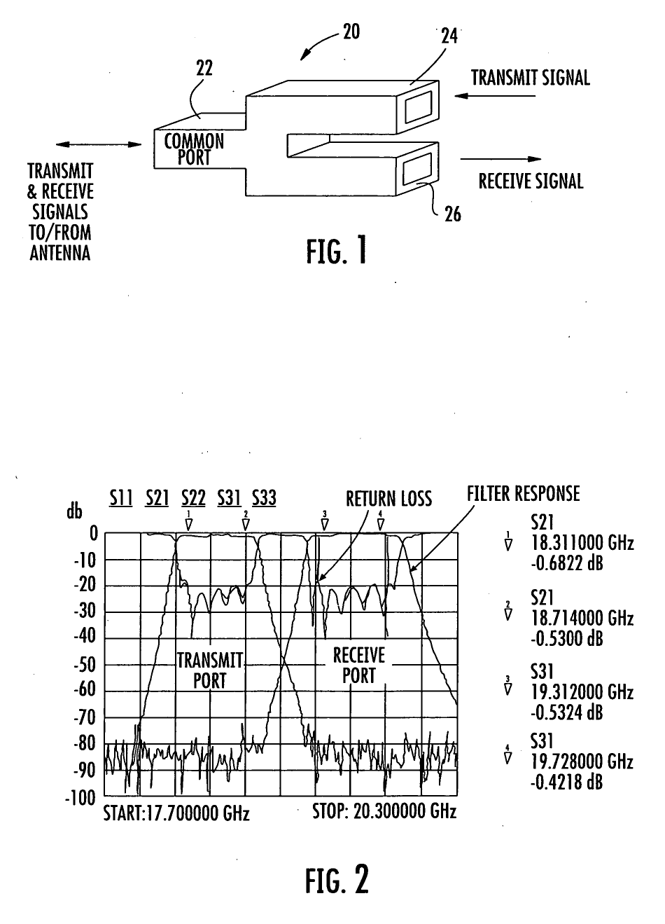

Waveguide diplexers have been used extensively in wireless communication systems to isolate the output transmitter signal from the receiver input signal. The diplexer is a coupling device that permits two radio frequencies to share the same antenna. A typical waveguide diplexer shown in FIG. 1 at 20 and is typically a three (3)-port, frequency dependent, passive device that may be used as a separator or combiner of signals. One port (a common port) 22 is usually connected to the antenna and carries both the receive and transmit signals. Once inside the diplexer, the transmit and the receive signals are separated using matched waveguide filters. The transmit port 24 and receive port 26 are illustrated.

FIG. 2 shows the frequency response and return loss of a typical diplexer operating at about 18 GHz. In this case the transmitter band is from about 18.3 to about 18.7 GHz, while the receiver band is from about 19.3 to about 19.7 GHz. These filters operate with the diplexer and provide great isolation (over 80 dB) between the transmitted and the received signals while maintaining a low level of Voltage Standing Wave Ratio (VSWR), which is represented by the measured return loss. A −20 to −15 dB return loss is typically desired in these types of applications.

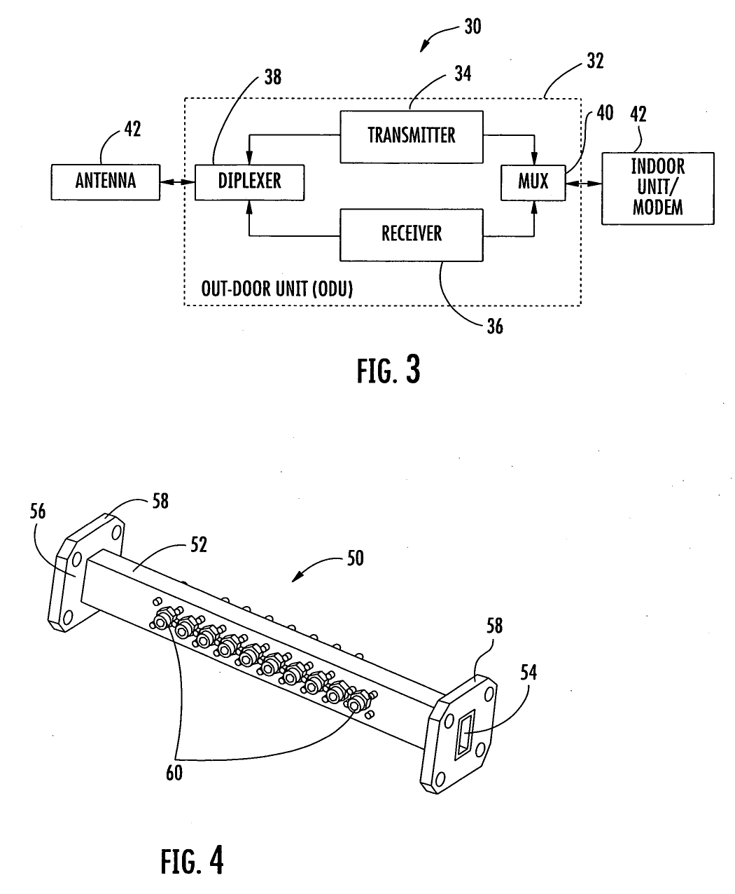

FIG. 3 shows a block diagram of a typical microwave communications system 30. The outdoor unit (ODU) 32 typically includes a transmitter 34, a receiver 36, a diplexer 38, as illustrated, and multiplexer 40, the antenna 42 receives a signal and forwards this signal to the diplexer 38, which is operative with the transmitter 34 and receiver 36. The multiplexer 40 is operative with the transmitter 34 and receiver 36 and the indoor unit/modem 42. Although the typical microwave communications system includes many more components than these basic components as illustrated, these components show the basic operating features of a diplexer 38 relative to an antenna 42 and a transmitter 34 and receiver 36 of an outdoor unit 32. As discussed previously, the diplexer 38 allows the transmitter 34 and the receiver 36 to operate at different frequencies and share the same antenna 42. The diplexer 38 is typically installed inside the ODU enclosure and becomes an integral part of the ODU 32, which is typically tested with the diplexer. If the customer ODU operating requirement changes to a different frequency segment, the ODU must be disassembled and a new diplexer is installed. The ODU is then retested again.

The most commonly used waveguide filters and diplexers are of the cavity type, which requires manual tuning with screws to set them to the desired frequency. These filters require precision machining and extensive manual tuning to set the desired frequency response.

FIG. 4 shows a typical waveguide filter 50 used in some communication systems to provide signal filtering and isolation between any transmitter and receiver signals. As illustrated, this type of waveguide filter 50 includes a longitudinally extending filter body 52 that is typically rectangular configured. An input port 54 and output port 56 are formed at the ends. A mounting plate 58 is positioned at each end to allow the filter to be mounted to an appropriate housing of a device and operative with the transmitter and receiver units. The filter 50 can be mounted using appropriate fasteners or other fastening means that extend through the mounting plate 58 to the device. A plurality of tuning screws 60 are arranged along the length of the filter body 52 as illustrated.

The length of this type of filter 50 is typically dictated by the amount of rejection and the number of required poles. To achieve high rejection with a sharp cut-off (>50 dB), 7 to 12 poles are required and the filter length could be several inches long. In addition to this large size, each filter requires precision machining and extensive manual tuning to set the filter frequency response. This tuning is achieved by adjusting the tuning screws 60, which are usually sealed to protect them when exposed to water or excessive humidity. The prevalent practice is to use an epoxy sealant over the screw locations after the tuning process.

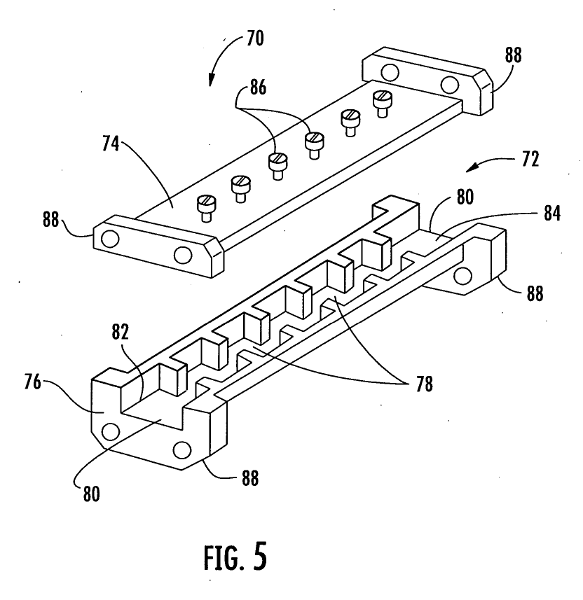

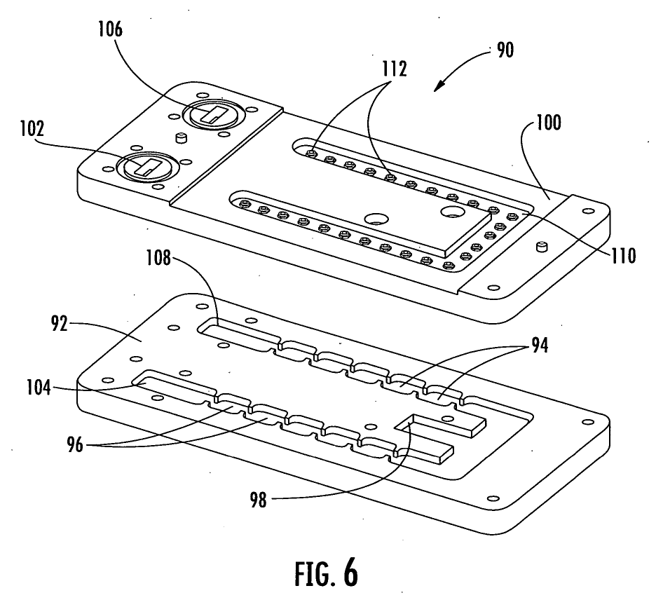

FIG. 5 shows a cavity filter 70 and FIG. 6 shows a diplexer. As illustrated in FIG. 5, this cavity filter 70 is similar in design to the waveguide filter, such as shown in FIG. 4. This cavity filter 70 includes a longitudinally extending filter body 72 formed from a filter cover 74 that is received on a filter housing 76. The filter housing 76 includes machined filter cavities 78 operative with a waveguide 80 at either end forming an input port 82 and output port 84. The filter cover 74 includes a plurality of tuning screws 86 that extend along its length and into each of the filter cavities 78 and provide the necessary tuning. End plates 88 provide for mounting.

FIG. 6 is an example of a typical cavity diplexer 90 that includes a diplexer base 92 having machined receive filter cavities 94 and transmit filter cavities 96 extending longitudinally along the base 92 parallel to each other. They are connected by a common waveguide port 98 as an antenna interface, which in this illustrated embodiment is configured as a “W”, thus forming with the receive and transmit filter cavities 94, 96 a substantial “U” configuration. A diplexer cover 100 a fastened on top of the diplexer base 92 by screw or other fastening means. The diplexer cover 100 includes a transmit waveguide port 102 that is operative with an enlarged transmit cavity 104 in the base and a receive waveguide port 106 operative with another enlarged receive cavity 108 in the base as illustrated. The diplexer cover 100 includes a U-shaped cavity 110 formed into the top surface of the diplexer cover 100. This cavity 110 is coextensive in configuration with the U-shaped configuration of the cavities 94, 96, 98 formed in the base 92. Tuning screws 112 are positioned in the cavity and extend into the various transmit and receive filter cavities 94, 96 and the common waveguide port 98 as part of the antenna interface.

The characteristics of this filter/diplexer 90 are determined by the number of cavities 94, 96 and their size. The cavities are typically precision machined. In addition to their high cost, cavity filters as illustrated provide no flexibility because each frequency segment requires unique cavity machining. Therefore, wireless radio manufacture must carry hundreds of waveguide filters/diplexers in inventory to cover wide frequency bands and be able to react to changes in customer requirements in a reasonable time. Here again, any filters/diplexers subjected to water or excessive humidity must also have their tuning screws sealed.

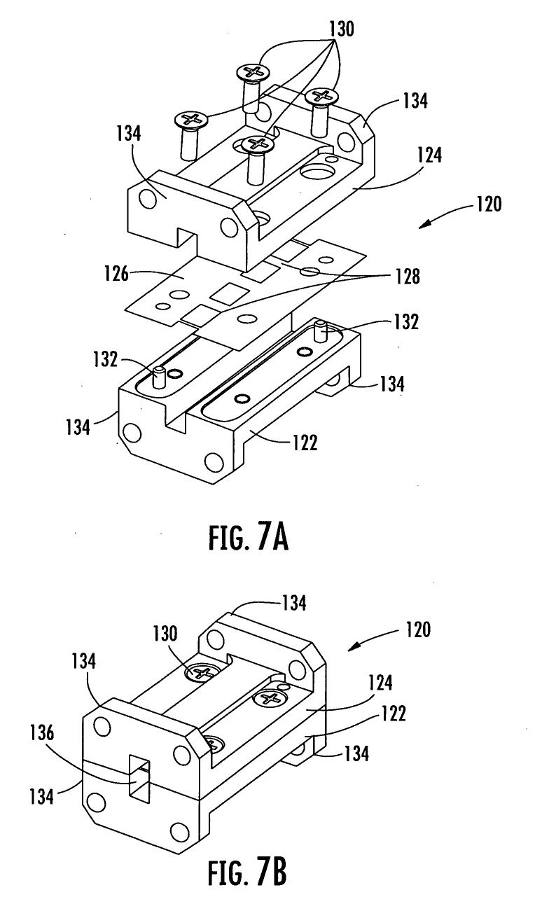

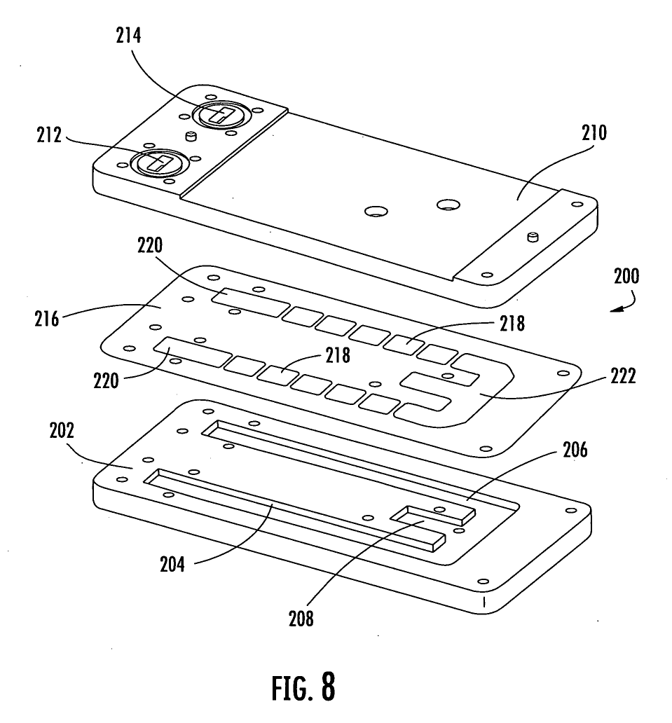

Another type of waveguide filter is the septum filter 120, shown in FIGS. 7A and 7B.

As illustrated, this septum filter 120 includes a bottom half body member 122 and top half body member 124 and an insert 126 with resonators 128 formed in the insert. The insert 126 is positioned between top and bottom half body members 122, 124 in the final assembled filter 120 as shown in FIG. 7B. Fasteners 130, such as screws, secure the top and bottom half body members 122, 124 together. Alignment pins 132 (FIG. 7A) act to align the two halves during assembly. The assembled filter 120 has a rectangular configuration formed by the top half body member 124 and bottom half body member 126. A mounting flange 134 on each end of the body members forms a mounting plate or bracket for the assembled unit. A waveguide 136 is formed at either end, becoming an input or output port as illustrated.

E-plane septum filters as described have been used since the 1970's due to their low cost, low loss and suitability for mass manufacturing techniques. Standard manufacturing techniques for these filters involve machining the body members forming the waveguide halves and photo-etching the septum insert 126. It currently costs about $20 (twenty dollars) per filter in present day costs to machine the waveguide halves. These filters do not require any tuning screws, and instead use the illustrated type of inserts, which are typically made of copper, beryllium copper (BeCu), aluminum, or other similar materials to form the filter resonators. An insert, which is about two to about six mils thick, is sandwiched between the two halves of the waveguides formed by the body members. This type of low cost insert 132 replaces the expensive precision machining required for cavity filters and the extensive tuning required for iris coupled filters.

Although septum inserts have been used to create individual waveguide filters, they have not been used to create full diplexers. In one non-limiting example of the present invention, a septum is used with a low cost diplexer and provides radio manufacturers the flexibility required to cover segmented frequency bands without requiring extensive disassembly and assembly and an inventory of expensive parts. As used herein, a septum can refer a thin metal or similar material vane or similar planer material that has been perforated with an appropriate wave pattern. When inserted into a waveguide; it can act as a filter/diplexer.

FIG. 8 is an example of a waveguide diplexer 200 in accordance with one non-limiting example of the present invention. As illustrated in this exploded isometric view of the diplexer 200, a diplexer base 202 does not include any transmit or receive waveguide cavities. Instead, a single U-shaped waveguide channel is formed. An individual transmit waveguide 204 and receive waveguide 206 are formed parallel to each other and connected by a common waveguide port 208 as an antenna interface, which connects the transmit and receive waveguides. The diplexer cover 210 includes transmit and receive waveguide ports 212, 214. A septum insert 216 is formed as thin, planer insert and fits over the diplexer base, extending between the diplexer base 202 and the diplexer cover 210, such that the assembled unit forms a diplexer 200 when assembled together.

The septum insert 216 includes rectangular configured openings 218 that are co-extensive with the transmit and receive waveguides 204, 206 when the septum insert is positioned on the diplexer base. A larger rectangular opening 220 is formed in the septum insert and received over the end portions of the transmit and receive waveguides 204, 206 and co-extensive with the transmit waveguide port 212 and receive waveguide port 214 formed in the diplexer cover 210. A common waveguide port opening 222 is formed in the septum insert and co-extensive with the area of the common waveguide port 208 on the diplexer base 207.

This non-limiting example of a diplexer as illustrated uses the septum insert to provide the required isolation between the transmitter and the receiver signals. The tuning screws used in a typical cavity diplexer have been eliminated. Without having to seal any tuning screws, this diplexer 200 can be assembled using standard dip-brazing or dip-soldering techniques to create an inherently weatherproof assembly. Any metal housing section forming the overall structure can be made up of a hollow waveguide with no machined cavities. The thin metal insert as the septum can be designed using electro-magnetic simulation tools such as High-Frequency Structure Simulation (HFSS), creating the filter resonators and providing the desired band segmentation. It should be understood that the septum insert can provide a filtering and a diplexer function. HFSS is adequate as a design tool because it typically uses a three-dimensional full wave finite element method (FEM) to compute the electrical behavior of high-frequency and high-speed components, such as waveguides. Engineers can extract parasitic parameters (S, Y, Z) in visualized three-dimensional near and far-field, electro-magnetic fields to generate broad band models and optimize design. Thus, a full-wave electrical characterization for radio frequency (RF), microwave and high-speed components such as waveguides, IC packages, connectors, printed circuit boards and antennas can be provided.

The thin metal inserts as septum inserts 216 can be fabricated using traditional chemical etching or stamping methods and cost under $5 (five dollars) in present day value. This allows radio manufacturers to stock low-cost, blank, waveguide diplexer housings and inserts for the different frequency segments. The diplexer frequency band can be selected at the last minute, just prior to shipment. Last minute changes to the diplexer requirements will not require retesting of the unit.

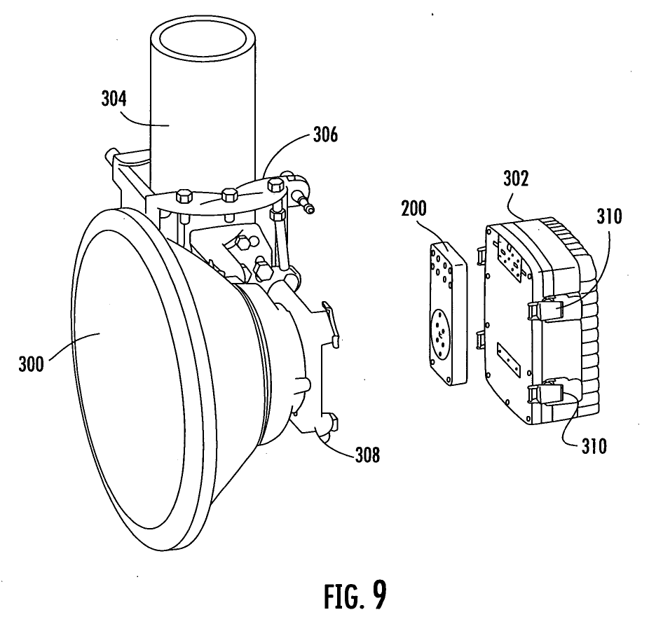

In order to achieve more flexibility in reacting to last minute changes in customer different diplexer demand, the diplexer 200 shown in FIG. 8 can be mounted outside the ODU. FIG. 9 shows how the diplexer 200 mounts between the antenna 300 and the ODU 302. As illustrated, the antenna 302 is typically mounted on a mounting pole 304 by a bracket assembly 306. The rear of the antenna 302 includes a mounting member 308, which is configured for receiving the outdoor unit 302 in a quick release connection using snap connectors 310 on the outdoor unit 302. The diplexer 200 is mounted on the outdoor unit 302 between the antenna 300 and the outdoor unit 302 as illustrated. An example of an outdoor unit that can be used in accordance with one non-limiting example of the present invention is disclosed in commonly assigned U.S. Publish Application No. 2004/0203528, the disclosure which is incorporated by reference in its entirety. This design allows the customer to change frequency segments without requiring a different outdoor unit. The frequency segment of operation can be selected, and with the use of the septum diplexer as explained above, the frequency band can be changed by merely using a different septum insert.

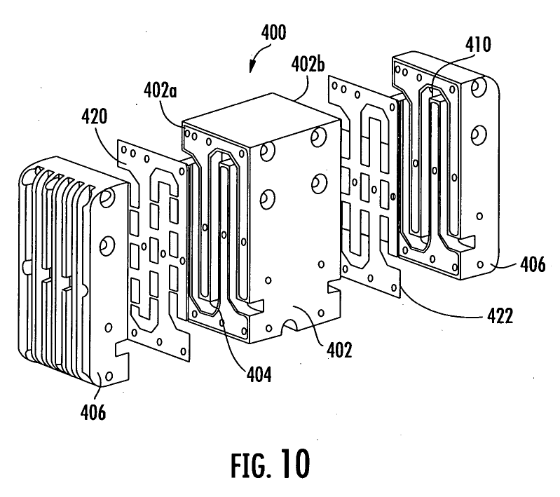

In applications where space is highly restricted, the septum inserts can be designed such that the filters and diplexers can be folded in a serpentine or similar configuration. A very compact design can be achieved in accordance with different embodiments of the present inventions. FIG. 10 shows a serpentine septum filter/diplexer. This filter allows the folding or multi-layering of the inserts to reduce the length of the filter.

As illustrated in FIG. 10, the combination filter and diplexer 400 includes a main housing or body 402 that is substantially rectangular configured and includes opposing surfaces 402a, 402b, each having a serpentine configured waveguide channel 404. An end cover 406 is received over each surface 402a, 402b and configured and sized in conformity with the body 402, as illustrated. Each cover 406 includes a serpentine waveguide channel 410 such that when the housing 402 and the two end covers 406 are assembled, the serpentine channels 410 in the two end covers are co-extensive with the serpentine channels 404 in the body to form a waveguide channel for an appropriate transmit waveguide and receive waveguide. Between each end cover 406 and the housing 402 a filter/septum insert is positioned. The channels and inserts are configured and formed such that one transmit filter insert 420 is positioned between a serpentine channel of the end cover and housing and forms a transmit waveguide and a receive filter insert 422 is positioned between the housing and serpentine of the end cover forming a receive end cover. Each insert includes a number of rectangular configured openings 424 as described before to form filter segments, as illustrated. The filter insert is made up of multiple segments (three segments in this case), each representing N number of poles. The segments are formed by each straight leg on the path defined by the serpentine configuration. This segmentation results in much smaller filter length. For example a 9-pole Septum filter at 20 GHz would be approximately 4.5 inches long, while a folded filter with three 3 segments is approximately 1.5 inches.

The septum diplexer and serpentine filters/diplexers as described can also be manufactured using die-casting for any waveguide halves. The potential exists for diplexers suitable for this application to be manufactured for about $5 (five dollars) in large quantity at present day values. Reduced manufacturing tolerance is possibly a tradeoff for the low cost manufacturing techniques. The standard tolerance on a machined waveguide half for an E-Plane filter is about ±2 mils. The waveguide halves can be die-cast with a tolerance of about ±3 mils.

A major manufacturing issue with die-casting is the necessity to have a draft angle on any waveguide halves to enable them to be easily removed from a mold after the molding process. A draft angle of at least about 2° is generally desirable for ease of manufacture, and the draft angle should be accounted for in the electrical design of the waveguide. When applying any draft angle to the waveguide, the new waveguide cross-section dimensions are set so that the cross-sectional area of the waveguide with draft angles is equal to the cross-sectional area of the standard waveguide. This gives the smallest mismatch when connecting a standard rectangular waveguide to a waveguide with a draft angle. The addition of a draft angle, however, to the waveguide also results in an increase in its wavelength and a decrease in its cut-off wavelength, the amount of each depending on the draft angle. A two degree draft angle corresponds to a 1.35% increase in the waveguide wavelength, and a 2.05% decrease in the cut-off wavelength. Adjustments should desirably be made to the septum insert design to compensate for these effects.

This design can offer several advantages. The low cost, septum waveguide diplexer as used for wireless communications systems can be made up of a metal housing, and are formed as a chemically etched, or stamped, metal insert, allowing flexible band pass selection. The septum diplexer can use a universal housing for frequency bands, within the waveguide cut-off frequency, and narrow frequency segments can be selected by interchanging inserts. The implementation of an external diplexer in wireless communication systems and outdoor units provides the ability to change diplexers without disassembling or retesting the outdoor unit, allowing frequency band adaptation in the field. Segmentation of filters through a serpentine septum waveguide filter/diplexer design reduces the waveguide filter/diplexer size without sacrificing performance or flexibility. Ease of manufacturing of the diplexer allows use of die-casting and implementing a low cost septum diplexer with meander-line filters. Dip-brazed septum waveguide diplexer assemblies are inherently weatherproof and do not require the extra measures currently used to seal any tuning screw locations.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A diplexer comprising:
a diplexer housing having transmit and receive waveguide channels formed therein;
a cover received on the diplexer housing over the transmit and receive waveguide channels; and
a septum inserted between the diplexer housing and cover and configured to provide isolation between any transmitter and receiver signals and a desired frequency band of operation.

2. A diplexer according to claim 1, wherein said transmit and receive waveguide channels are each serpentine configured.

3. A diplexer according to claim 1, wherein said diplexer housing includes opposing sides and the respective transmit and the receive waveguide channel are formed on the opposing sides.

4. A diplexer according to claim 3, and further comprising an end cover received over each opposing side.

5. A diplexer according to claim 4, wherein each end cover has a respective waveguide channel engaging the respective waveguide channel within the housing.

6. A diplexer according to claim 1, and further comprising a common waveguide port interconnecting transmit and receive waveguide channels.

7. A diplexer according to claim 1, wherein said septum comprises formed resonators for imparting a desired frequency band of operation and isolation between transmitter and receiver signals.

8. A diplexer according to claim 1, wherein said waveguide channels comprise multiple segments, each representing “n” number of poles.

9. A diplexer according to claim 1, wherein said diplexer housing comprises a base plate.

10. A diplexer according to claim 1, wherein said cover includes a transmit and receive waveguide port formed therein and operative with said transmit and receive waveguide channel.

11. A diplexer according to claim 1, wherein said diplexer is configured to be mounted on an outdoor unit between an antenna and the outdoor unit.

12. A microwave communications system comprising:
an antenna;
an outdoor unit mounted on the antenna;
a diplexer mounted between the antenna and outdoor unit comprising,
a diplexer housing having transmit and receive waveguide channels formed therein;
a cover received on the diplexer housing over the transmit and receive waveguide channels; and
a septum inserted between the diplexer housing and cover and configured to provide isolation between any transmitter and receiver signals and a desired frequency band of operation.

13. A microwave communications system according to claim 12, wherein said transmit and receive waveguide channels of said diplexer are each serpentine configured.

14. A microwave communications system according to claim 12, wherein said diplexer housing includes opposing sides and the respective transmit and the receive waveguide channel are formed on the opposing sides.

15. A microwave communications system according to claim 14, wherein said diplexer further comprising an end cover received over each opposing side.

16. A microwave communications system according to claim 15, wherein each end cover has a respective waveguide channel engaging the respective waveguide channel within the housing.

17. A microwave communications system according to claim 12, wherein said diplexer further comprises a common waveguide port interconnecting transmit and receive waveguide channels.

18. A microwave communications system according to claim 12, wherein said septum comprises formed resonators for imparting a desired frequency band of operation and isolation between transmitter and receiver signals.

19. A microwave communications system according to claim 12, wherein said waveguide channels of said diplexer comprise multiple segments, each representing “n” number of poles.

20. A microwave communications system according to claim 12, wherein said diplexer housing comprises a base plate.

21. A microwave communications system according to claim 12, wherein said cover of said diplexer includes a transmit and receive waveguide port formed therein and operative with said transmit and receive waveguide channel.

22. A microwave communications system according to claim 12, wherein said outdoor unit includes a quick connect/disconnect to said antenna.
